(19) United States
(12) Patent Application Publication
(10) Pub. No.: US 2017/0239875 A1
(43) Pub. Date: Aug. 24, 2017

(54) METHOD AND APPARATUS FOR TEMPERING THE NECK END REGION OF MOLDED PREFORMS

(71) Applicant: Otto Manner Innovation GmbH, Bahlingen (DE)

(72) Inventor: Gheorghe George Olaru, Freiburg (DE)

(21) Appl. No.: 14/265,292

(22) Filed: Apr. 29, 2014

(30) Foreign Application Priority Data
Apr. 29, 2013 (DE) 102013007417.7

(51) Int. Cl. B29C 49/64; B29C 35/16

(52) U.S. Cl. CPC B29C 49/64; B29C 35/16

(57) ABSTRACT

An apparatus for cooling molded preforms may comprise a conveyor device for conveying the molded preforms and a tempering insert. The conveyor device may also comprise an extraction plate that contains a cooling cavity for receiving and cooling a closed section of a molded preform. The tempering insert may be connected to the conveyor device and be configured to temper a neck region of the preform by direct contact. The tempering insert may be designed to both temper and accommodate a preform in the conveyor device. The apparatus may further comprise a heat pipe that is configured to draw heat from the cooling cavity to cool the closed section of the preform.

The present invention relates to the injection molding and cooling of hollow objects. More precisely, the present invention relates to an injection molding method and an injection molding and cooling apparatus for molded preforms suitable for blow molding, wherein the preforms comprise a threaded neck end region and cooling steps are not performed until the preforms are removed from the mold cores.

Much effort is expended in reducing the cycle time in the manufacture of molded preforms suitable for blow molding which are made from a variety of plastics such as e.g. PET. Preform molds usually exhibit a closed section and an open section at the preform's opposite end. The open section is called the neck end and normally exhibits a specific thread.

One known possibility for reducing the cycle time is shortening the cooling time of the molded preform in the closed mold, wherein the cooling process continues on the preform after it is removed from the mold.

There are many known methods and apparatus for cooling preforms such as PET preforms after the actual injection molding and after the preforms having been removed from the mold cores. Many methods use coolants such as water to cool the molded objects. It is however difficult when doing so to keep the cooling action constant for a plurality of objects such as preforms which have been simultaneously molded and are to be cooled such that the cooling step will not be completed until after those preforms which have heated the coolant normally flowing by a plurality of them the most have been sufficient cooled. The extracting and transferring of the preforms from the mold cores into a cooling apparatus as well as accommodating them therein also proves difficult due to the premature removal of the preforms from the mold since the preforms are still malleable.

The invention is therefore based on the objective of improving the cooling of the preforms as well as improving the handling of the preforms during the cooling process.

This objective is inventively accomplished by the teaching of the independent claims. Preferential further developments of the invention form the subject matter of the subclaims.

The present invention relates to an apparatus for cooling molded preforms having a conveyor device for conveying the molded preforms, wherein the conveyor device comprises at least one extraction plate having at least one cooling cavity for receiving and cooling a closed section of a molded preform. The apparatus further comprises at least one tempering insert connected to the conveyor device for tempering a neck region of the preform by direct contact and which is designed to both temper as well as accommodate a preform in the preform conveyor device.

The molded preforms are preferably intended to be subsequently blow molded. They comprise a body having a closed section and an open section on the other end. The open section is called the neck end and in preferred embodiments of the invention, the neck end is provided with a specific thread.

In some embodiments of the invention, the neck end of the molded preform, which preferably comprises a specific neck end thread, is tempered after the preform is removed from the mold cores by direct contact with one, preferably a plurality of, in particular two, tempering inserts connected to a preform conveyor device.

In some embodiments of the invention, the neck end of the molded preform, which preferably comprises a specific neck end thread, is cooled after the preform is removed from the mold cores, particularly by direct contact with one, preferably a plurality of, in particular two, cooling inserts connected to a preform conveyor device.

In some embodiments of the invention, the neck end of the molded preform, which preferably comprises a specific neck end thread, is heated after the preform is removed from the mold cores, by direct contact with one, preferably a plurality of, in particular two, heating inserts connected to a preform conveyor device.

In some embodiments of the invention, the neck end of the molded preform, which preferably comprises a specific neck end thread, is tempered after the preform is removed from the mold cores, by direct contact with one, preferably a plurality of, in particular two, tempering inserts connected to a preform conveyor device. The tempering insert is thereby designed such that it can heat or cool the preform, or heat and then subsequently cool the preform, or also first cool and then subsequently reheat the preform.

The inventive apparatus further comprises a conveyor device which is preferably suited to removing the preforms from the mold cores. The conveyor device serves to transfer the preforms within the preform manufacturing apparatus. In particular, the conveyor device accommodates preferably at least one section of the preforms, preferentially at least substantially in form-fit manner, transfers the preforms into and/or to another position and releases the preforms at a predetermined location enabling another conveyor device to receive the preforms, and/or actively releases the preforms from the conveyor device.

In some embodiments of the invention, the conveyor device comprises preform cooling cavities for cooling the exterior of the molded preforms. The cooling cavities can thereby also be configured in cooling tubes arranged on the conveyor device.

The cooling cavities are thereby designed such that they preferably accommodate the closed section of the preform in substantially direct contact so as to enable good heat transfer between the cooling cavity and the preform, whereby in addition to heat transfer by conduction, heat transfer by radiation or by convection is preferably also possible.

In some embodiments of the invention, the conveyor device comprises preform cooling pins or preform cooling cores for cooling the interior of the molded preforms.

In some embodiments of the invention, the conveyor device comprises a combination of preform cooling pins or preform cooling cores for cooling the interior of the molded preforms and preform cooling cavities for cooling the exterior of the molded preforms. This enables particularly effective preform cooling from both sides of its wall.

In some embodiments of the invention, the conveyor device has a combination of preform neck region cooling for some sets of preforms and preform neck region heating for other sets of preforms. This thereby enables cooling the preferably threaded neck region of some sets of preforms and heating the preferably threaded neck region of other sets of preforms. In one preferred embodiment of the invention, the conveyor device is configured such that preferably the preform neck region is first cooled and then subsequently reheated or that the preform neck region is first heated and then subsequently cooled down again.

In one embodiment of the invention, a first set of such molded preforms is removed from the mold cores and transferred to a movable linear or rotary extraction plate, wherein the extraction plate is part of the conveyor device. The extraction plate comprises cooling tubes, respectively cooling cavities, and tempering inserts which serve to cool and/or heat the neck region of the preforms.

The molded preforms are preferably arranged on the extraction plate in the form of an ordered array of preforms. The preforms in the ordered array can thereby be arranged in rows which are aligned and/or offset to one another or in another fitting arrangement. In some embodiments of the invention, the spacing between the preforms forming the ordered array corresponds in distance to the spacing of the mold cores and cavities of the mold used to manufacture the preforms. That means that the cooling tubes or cooling cavities of the extraction plate are preferably arranged so as to be aligned relative to the mold cores.

In some other embodiments of the invention, the spacing between the preforms forming the ordered array does not correspond in distance to the spacing of the mold cores and mold cavities used to manufacture the preforms. This can be advantageous particularly when the extraction plate has different dimensions than the mold or when another arrangement is advantageous particularly for subsequent process steps.

The cooling tubes or cooling cavities respectively surround the closed section of the molded preform bodies and provide direct contact cooling or contactless cooling of the outer surfaces of the preforms which are part of the closed body section of the molded preforms. Contact cooling enables a good direct transfer of heat between the cooling cavity and the preforms by way of conduction. Contactless cooling of the outer surfaces of the preforms enables a transfer of heat between the cooling cavity and the preform by way of radiation or convection. Preferentially, however, the cavity can also be designed so as to achieve a combination of contactless and contact cooling. While contactless tempering demonstrates lower heat transfer, the risk of damaging the still malleable surface of the still insufficiently cooled preform is thereby lower.

In one embodiment of the invention, the neck end region of the molded preforms, which is threaded, is kept out of the cooling tubes and/or cooling cavities. One set of tempering inserts arranged on the cooling tubes/cooling cavities is used to cool or heat the neck region of the preforms by directly contacting said neck end. The neck cooling inserts have an inner threaded surface which matches the outer surface of the preform neck end. Thus, on one hand, good heat transfer is enabled between the neck end region and the tempering inserts at the neck end surface and, on the other hand, the dimensional stability of the neck end region thread is thereby supported. The tempering inserts consist of a plurality of and preferentially two sections which can be separated from one another in order to receive or release the neck region of the preforms; i.e. grip or ungrip.

In one embodiment of the invention, the neck tempering inserts are used to eject the preforms from the molds or remove the preforms from the mold cores and/or to remove and/or transfer the molded preforms from the cooling tubes/cooling cavities of the preform conveyor device. Preferably, the preforms are transferred to a transporting device via the neck tempering inserts. Advantageous when using the neck tempering inserts to transport the preforms is that both functions can be performed by one single device and thus a respective device does not need to be provided for each of the two functions. It is further advantageous that, due to the form of the tempering insert retainers corresponding to the preforms, the shape of the neck end region of the preforms is protected against deformation both during tempering as well as during transporting. In addition, at least part of the tempering process and the conveying process can occur simultaneously.

In one embodiment of the invention, the neck cooling inserts are used to eject, remove or transfer the molded preforms from the cooling tubes/cooling cavities of the preform conveyor device and into a second cooling device comprising cooling cores or cooling pins. Additional cooling inserts are used in this cooling device in order to temper the neck region either by cooling or by heating. Heating is selected when it is desirous for PET preforms to have a crystallized neck.

In one embodiment of the invention, the neck cooling inserts are used to eject, remove or transfer the molded preforms from the cooling tubes/cooling cavities of the preform conveyor device and into a preform handling conveyor device which directly or indirectly transfers the preforms into a blow-molding device coupled with the injection molding process as a single-stage injection and blow-molding process.

The at least one tempering insert of the apparatus for tempering the preform neck region is connected to an ejection device. The ejection device is preferably designed such that it serves to withdraw the preforms located in the cooling cavities out of said cooling cavities, wherein the tempering inserts initially remain disposed on the preform neck region. To eject the preform from the conveyor device, the at least one tempering insert can be brought into an eject position at which the preform is released from the tempering insert in its open position. Preferably, the tempering inserts do not open to release the preforms until after the preforms have been removed from the cooling cavities. The tempering inserts thereby combine two functions, the tempering of the neck end region and the accommodating of the molded preform in the conveyor device. Doing so constitutes a consolidated and economical solution.

The present invention further relates to an apparatus for cooling molded preforms having a conveyor device for conveying the molded preforms which comprises at least one extraction plate having at least one cooling cavity for accommodating and cooling a closed section of a molded preform. The apparatus further comprises at least one tempering insert connected to the conveyor device for tempering a neck region of the preform by direct contact, wherein heat can be drawn from the cooling cavity by at least one heat pipe to cool the closed section of the preform.

A heat pipe in the sense of the invention is a device made from an especially heat-conductive material such as particularly copper, aluminum or an alloy particularly comprising the aforementioned metals. A heat pipe is preferably of substantially elongated design and extends from an area of higher temperature to an area of lower temperature. Due to the heat pipe material's good heat conductivity, which is usually greater than the heat conductivity of the medium surrounding the heat pipe, a heat pipe conveys thermal energy from the area of higher temperature to the area of lower temperature. One advantage of using a heat pipe is that no energy is required for its heat-conducting function. Thus a heat pipe is a particularly economical as well as resource-conserving device.

With the present apparatus for cooling molded preforms, at least one heat pipe is used to cool the closed section of the preform. One end of the heat pipe is thereby arranged in the immediate vicinity of the preform cooling cavity. Preferably, the heat pipe extends from an area directly adjacent the cooling cavity which has a higher temperature to an area distanced from the cooling cavity's proximity, preferably the environment external of the extraction plate, in which a lower temperature prevails than in the vicinity of the cooling cavity. The thermal energy escapes into the environment at that point. The material surrounding the cooling cavity thereby has lower heat conductivity than the heat pipe.

In one preferential embodiment of the invention, the at least one heat pipe of the apparatus for cooling molded preforms is connected to a heat dissipation area. The heat dissipation area is designed to conduct the thermal energy supplied by the heat pipe to an area of lower temperature, preferably into the environment. Preferably, the heat dissipation area is likewise designed from a material having good heat conductivity so that it can release the thermal energy reaching the heat dissipation area into the environment at sufficient speed. It is thereby preferential for the heat dissipation area to have a large surface, preferably cooling fins, across which the thermal energy can readily flow off into the environment. It is further preferential for the surface of the heat dissipation area to be designed so as to enable good thermal outflow. To this end, the surface for example exhibits a suitable surface structure, color or coating. It is also possible for the heat dissipation area to be formed directly by the heat pipe itself.

In a further preferential embodiment of the invention, the apparatus comprises a ventilator device which effects a flow of air in the region of the heat dissipation area of the at least one heat pipe. A flow of air accelerates the thermal output from the heat dissipation area, whereby the temperature in the region of the heat dissipation area drops and the thermal outflow from the cooling cavity area thus increases. Using a ventilator device can thus heighten the cooling effect of the at least one heat pipe on the preform.

The invention further relates to a method for cooling molded preforms. In said method, at least one preform is first manufactured in an injection molding process, then removed from its mold core and transferred to a preform conveyor device. A closed section of the preform is subsequently cooled and, at the same time, a neck region of the preform tempered by direct contact with at least one tempering insert in the preform conveyor device.

Further advantages, features and possible applications of the present invention are indicated in the following description in conjunction with the figures.

Shown are:

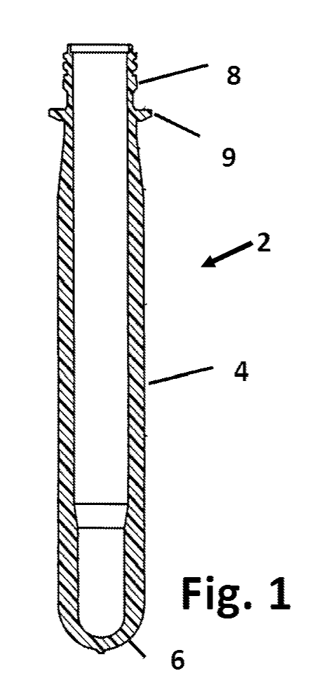

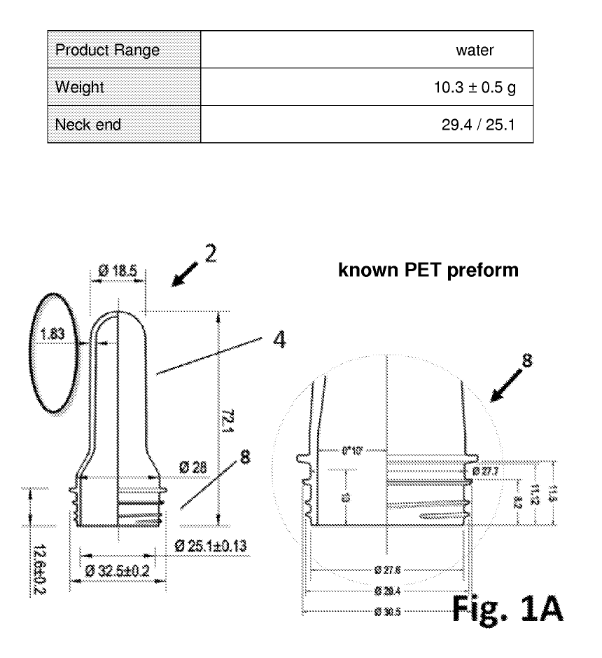

FIG. 1: a preform to be subsequently blow molded;

FIG. 1A: a known PET preform for bottles;

FIG. 1B: a further known PET preform for bottles;

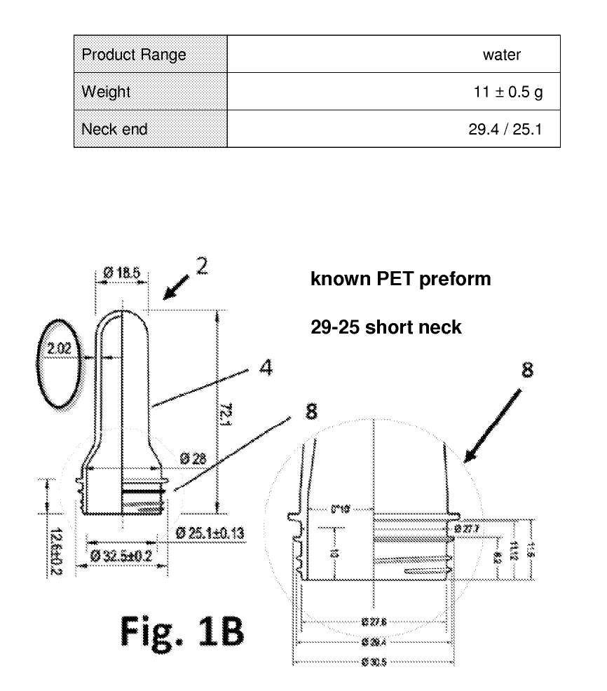

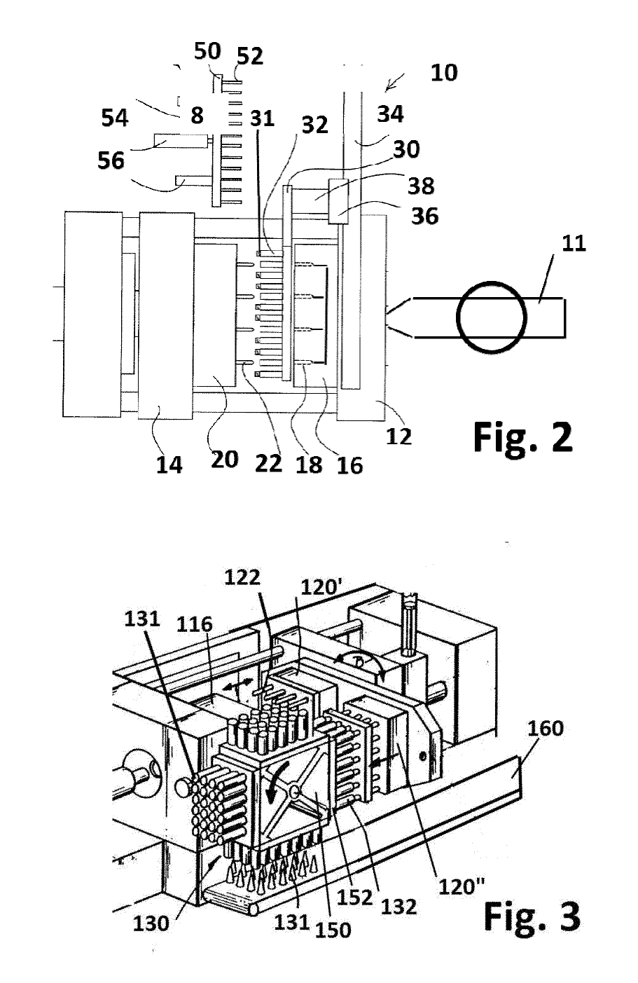

FIG. 2: a side view of one embodiment of the invention;

FIG. 3: a perspective view of a further embodiment of the invention;

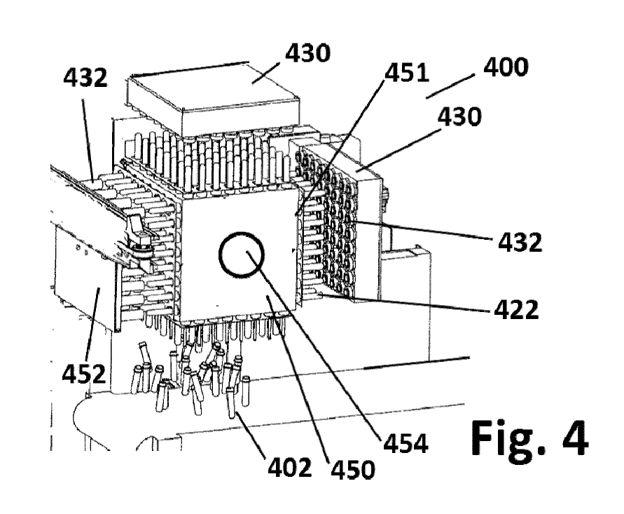

FIG. 4: a perspective view of a further embodiment of the invention;

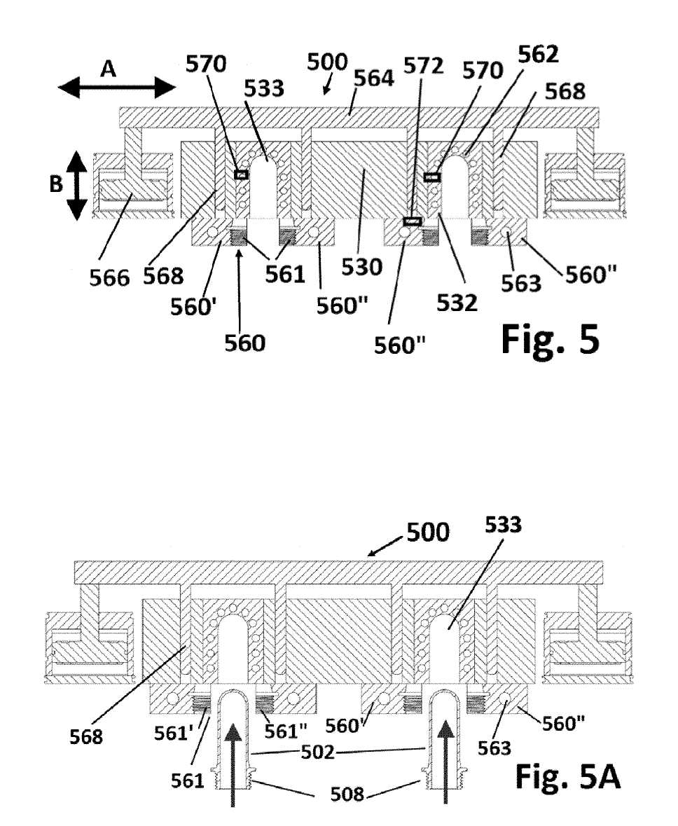

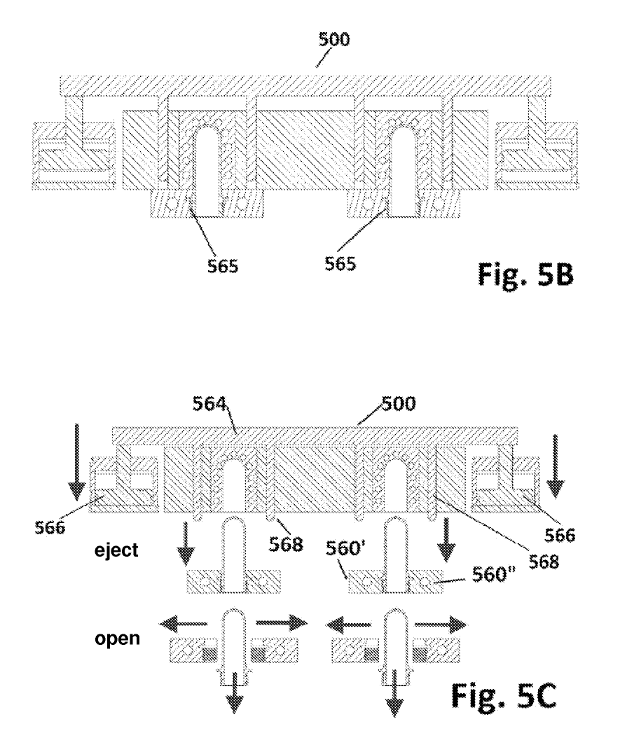

FIG. 5, 5A, 58, 5C sectional views of a further embodiment of the invention;

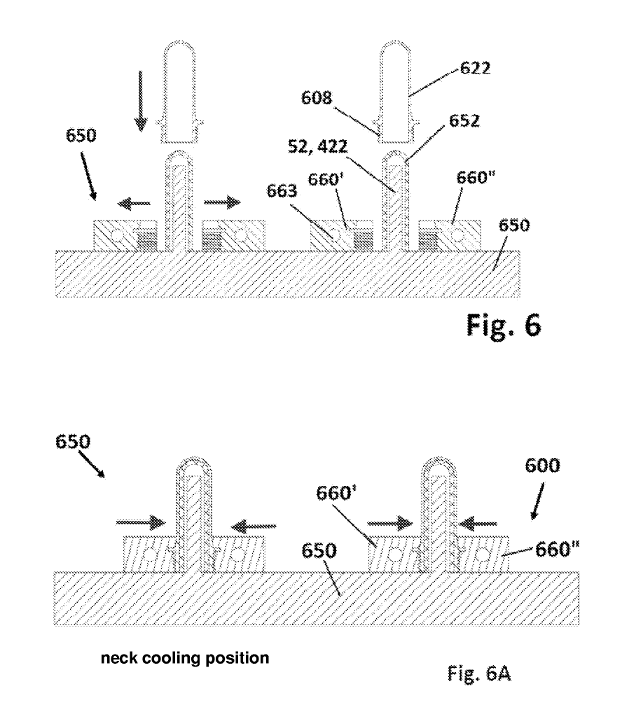

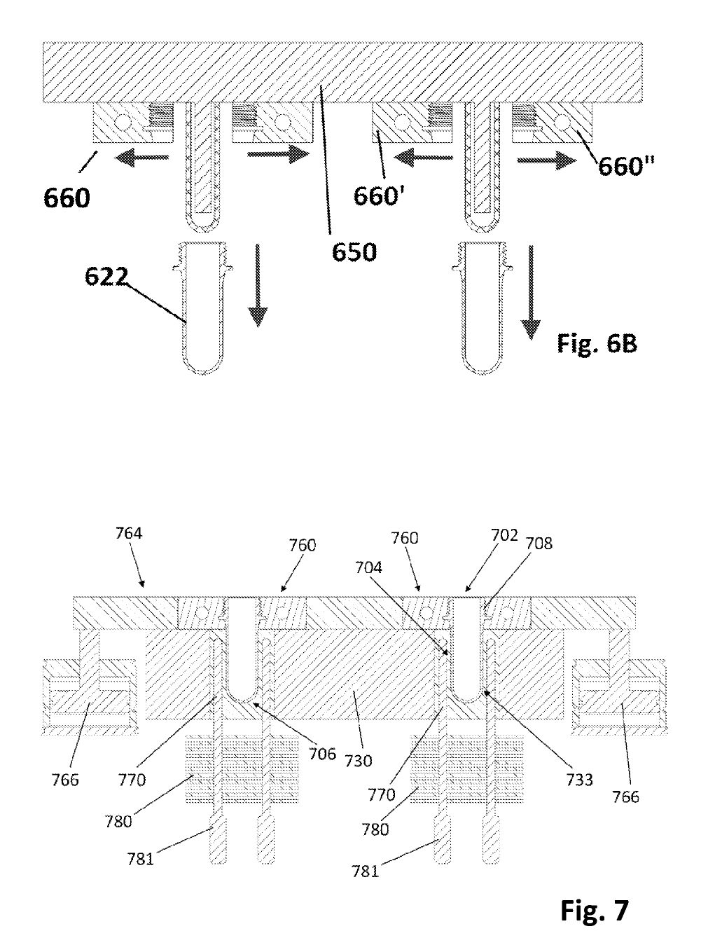

FIG. 6, 6A, 6B sectional views of a further embodiment of the invention;

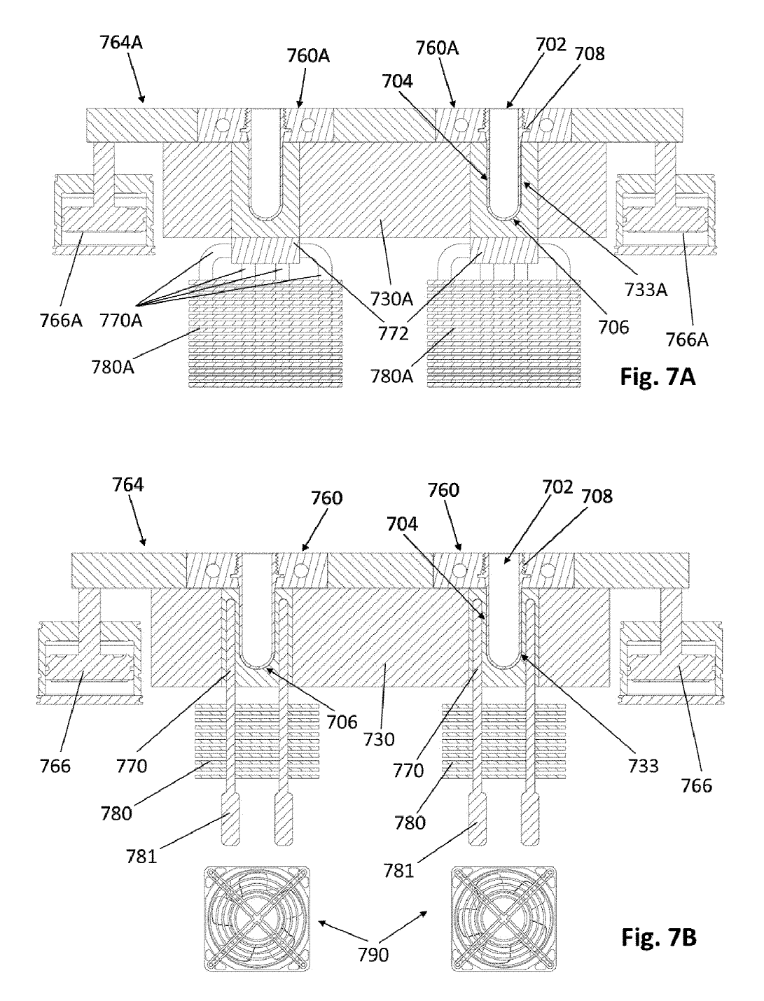

FIG. 7: sectional view of a further embodiment of the invention;

FIG. 7A: sectional view of a further embodiment of the invention; and

An injection molding and cooling apparatus for hollow blow-moldable preforms uses tempering inserts which in terms of their design, correspond to the threaded neck end of the preform. The tempering inserts are coupled to an extraction plate, an extraction frame or other similar preform conveyor device which indirectly or directly collects the freshly molded preforms from the mold cores used to manufacture said preforms. The tempering inserts can cool or heat the neck end. These tempering inserts are connected to cooling tubes or cooling cores arranged external of the mold cavities and serve to cool the rest of the preform not provided with a thread. The tempering inserts can be connected to an ejection mechanism which enables removal of the preforms from the cooling tubes/cooling cavities or the cooling cores.

FIG. 1 shows a blow-moldable preform 2 having a closed body section 4, a dome-shaped region 6 and a neck region 8 provided with a thread.

The threaded neck region 8 must be shaped as precisely as possible, as shown in the known preforms of FIGS. 1A and 1B. The threaded neck ends of these two preforms exhibit the same dimensions but the FIG. 1A preform is lighter than the FIG. 1B preform and also has a thinner wall in closed body section 4.

A higher output of molded preforms from the same mold allows higher yields using the same equipment. One possible option for increasing the output is to reduce the cycle time for the post-injection cooling and the extraction of the preform 2 (not shown in FIG. 2) from the mold halves 16 to 22 (not shown in FIG. 2). In the present embodiment of the invention, the preforms 2 are extracted from the mold cores 22 and immediately transferred to the extraction plate/frame 30 which is brought between the mold halves 16, 20 via the actuating means 34, 36, 38. The extraction plate/frame 30 has an array or matrix of cooling tubes or cooling cavities 32 respectively, wherein the cooling cavities are formed in cooling tubes in the present embodiment.

The extraction plate/frame 30 is depicted in greater cross-sectional detail in FIGS. 5 to 5C. FIG. 5 depicts the extraction plate 30 as extraction plate 530 and a portion of the extraction arrangement 500. Cooling cavities 533 are disposed in the extraction plate 530, in the immediate vicinity of which cooling channels 562 are arranged through which a coolant such as e.g. cooling water flows to cool the cooling cavity 533. The coolant thereby has a distinctly clearly lower temperature than a preform 508 to be cooled.

In this arrangement, the cooling cavities 533 are empty and thereby ready to directly receive the preforms 502 from the injection cores 22 of FIG. 2 or from the cores 122 as shown in FIG. 3. The extraction plate 530 further comprises tempering inserts 560 which in the present embodiment are formed by two movable mirror-image inserts 560′ and 560″. The inserts 560′ and 560″ exhibit a threaded region 561 formed on the tempering inserts 560′ and 560″ as regions 561′ and 561″ so as to establish a good contact with the neck region of the preform 2. Temperature control channels 563 are formed in the tempering inserts 560 through which a temperature control liquid such as e.g. water flows to regulate the temperature of the tempering inserts. For cooling the preforms, the temperature control liquid thereby has a distinctly clearly lower temperature and for heating the preforms, a distinctly clearly higher temperature than the threaded region of the preform 508.

The extraction plate 530 also comprises a preform ejection device 564 having ejecting rods 568 movable along the cooling cavities 533. In FIG. 5, the inserts 560′ and 560″ are in a first open position which allows the preforms to enter into the cooling tube. As shown in FIGS. 5B and 5C, as soon as the preforms are in the cooling cavities 533, the tempering inserts 560 move into a closed position in which there is direct contact 565 with the threaded neck end 508 of the preform 502.

Depending on the application, the length of the process and the purpose of the preform 502, the tempering inserts 560 are used to further cool or heat the neck end 508 of the preforms 502. Heating is less common albeit essential to crystallizing the neck region 508 externally of the mold.

As FIG. 5C shows, as soon as they have sufficiently cooled, the preforms are ejected by the ejecting rods 568 of the preform ejection device 564. The ejecting rods 568 are actuated by actuator 566. The preforms separate from the inserts due to the sideways opening of the tempering inserts 560′ and 560″ effected by control cams (not shown) or by means of other mechanisms interacting with the ejecting rods.

It is just as possible for the preforms 2, 402 to be transferred to cooling cores 52, 422. Suitable cooling cores 52 are shown in FIG. 2 and equally suitable cooling cores 422 are shown in FIG. 4.

Such cooling cores 52 and 422 are shown in more detail in FIGS. 6, 6A and 6B, whereby the neck end 608 of the preform 622 is cooled or sometimes also heated using tempering inserts 660′ and 660″. The cooling cores 52, 422 are thereby arranged on a cooling core plate 50, 650 which can, depending on the design of the mold 16, 22, also assume the function of an extraction plate or to which the preforms 2, 402 are transferred from the extraction plate in a second conveying step. The cooling core plate 50, 650 is arranged in the immediate vicinity of the tempering inserts 660. In FIGS. 6 to 6B, a cooling element 652 is arranged on the cooling core plate 650 which ensures the dimensional stability of the preform 622 and transfers the cooling power from the cooling core 52, 422 to the preform 622.

FIGS. 6 to 6B shows how the tempering inserts 660, through which a tempering liquid flows in tempering channels 663, act as part of the conveyor device. In FIG. 6, the tempering inserts 660 are in an open position in order to receive the threaded neck end region 608 of the preform 622. In FIG. 6A, the tempering inserts 660 are in a closed position and thereby positively hold the preform 622 at its neck end region 608, keeping it on the cooling core plate 650. In FIG. 6B, the tempering inserts 660 move into an opened position in which the preforms 622 are no longer held on the cooling core plate 650 and can thus be removed from same. Combined with a further suitable ejection mechanism or with a suitable arrangement drawing on the effect of gravity acting on the weight of the preforms 622 themselves, the tempering inserts 660 thus also serve in ejecting the preforms from the cooling and/or conveyor device.

For the further conveying and cooling of the preforms, the cooling cavity 32 and the extraction plate 30 in the FIG. 2 embodiment are transferred out of the injection chamber defined between mold halves 16 and 20. For example, the preforms 2 can be transferred while accommodated within the cooling cavities 32 formed in the cooling tubes 32.

As FIG. 5 shows, temperature sensors 570, 572, such as for example thermocouples, are arranged at various positions on the extraction plate 530 in order to monitor the temperature of each preform or the temperature of the cooling cavities 533 or cooling inserts 560. This preform temperature information can be used to regulate injection molding parameters such as for example the temperature of the molten material exiting a hot runner nozzle system 18 disposed in mold half 16.

FIGS. 7 to 7B show a sectional view of a further embodiment of the invention. Cooling cavities 733 in which a preform 702 is accommodated are arranged in the extraction plate 730. Tempering inserts 760 are arranged on the extraction plate 730, each accommodating a preform 702 in substantially positive manner in the depicted closed position.

The tempering inserts 760 are connected to an ejection device 764 which is movable in the direction of the longitudinal axis of the preforms 702 by means of actuators 766 in order to move the preforms into or out of the cooling cavities 733. During the ejecting process, the ejection device 764 moves the preforms 702 out of the cooling cavities 733 by means of actuators 766. The tempering inserts 760 shown in the closed position then withdraw sideways from the neck end region 708 of the preforms into an open position in which the preforms 702 are no longer held and thus expelled.

Heat pipes 770 are arranged in the immediate vicinity of the cooling cavities 733 which run in the longitudinal direction of the preforms 702 along the closed section 704 and past the dome-shaped region 706 from the interior of the extraction plate 730 out into the open. The heat pipes 770 thereby consist of a material having higher thermal conductivity than the area of the extraction plate in which the cooling cavity 733 is formed. The heat pipes 770 thereby conduct thermal energy from the area in direct proximity to the cooling cavity 733 to the open area in which the temperature is lower than at the cooling cavity.

The heat pipes 770 are connected to a heat dissipation area 780, 781 having a large surface so as to be able to quickly release the thermal energy to the environment. The heat dissipation area 781 is formed directly on the heat pipe 770 and has an enlarged cross-sectional area compared to the other areas of the heat pipe. In order to increase the thermal output and thus the thermal energy able to be conducted out of the cooling cavity 733, the heat pipes 770 are connected to a further heat dissipation area 780 which comprises a plurality of heat sinks arranged in the manner of cooling fins. The heat sinks and thus heat dissipation area 780 have a large surface area and can thereby emit large amounts of heat to the environment, particularly without needing to expend additional energy in doing so.

FIG. 7A shows a further embodiment of heat pipes 770A comprising a heat dissipation area 780A. The design of extraction plate 730A, the cooling cavities 733A and the ejection device 764A along with tempering inserts 760A and actuators 766A correspond to that of the same elements shown in FIG. 7. The heat pipes 770A in this embodiment are arranged on a heat transfer element 772 disposed on the extraction plate 730A in the immediate vicinity of the cooling cavity near the dome-shaped region 706 of the preform 702.

In the embodiment of FIG. 7A, four heat pipes 770A run out from the heat transfer element 772 and extend in a direction away from the extraction plate 730A. On their opposite end from the heat transfer element 772, the heat pipes 770A are connected to a heat dissipation area 780A consisting of a plurality of heat sinks and thus likewise having a large surface area for conducting larger amounts of heat into the environment. In this embodiment, a plurality of heat pipes 770A are connected to heat dissipation area 780A, thereby improving the transfer of heat from the heat pipes 770A at a cavity to their heat dissipation area 780A.

FIG. 7B shows a further embodiment of the invention. The elements depicted in FIG. 7B correspond substantially to the elements depicted in FIG. 7 such that reference is made to the description of FIG. 7. In addition to the implementation as in FIG. 7, the embodiment of FIG. 7B comprises ventilator devices 790 which conduct a flow of air onto heat dissipation area 780 and 781 in order to accelerate the release of heat from the heat dissipation area 780 and 781 and thus increase the amount of heat released into the environment. The ventilator devices 790 are thus configured so that the dispensed airflow will pass over the largest possible surface area of the heat dissipation areas 780 and 781. The ventilator device 790 thus intensifies the cooling action of the at least one heat pipe 770 on the preform 702.

1. An apparatus for cooling molded preforms (2, 422, 502, 622, 702) comprising:
a conveyor device (30, 34, 36, 38, 500, 530, 650, 730) for conveying the molded preforms (2, 422, 502, 622, 702);
the conveyor device comprising at least one extraction plate (30, 530, 730, 730A) having at least one cooling cavity (32, 533, 733) for receiving and cooling a closed section (4, 704) of a molded preform (2, 422, 502, 622, 702);
at least one tempering insert (560, 660, 760) connected to the conveyor device (30, 34, 36, 38, 500, 530, 650, 730) for tempering a neck region (8, 508, 608, 708) of the preform by direct contact; and
the at least one tempering insert (560, 660, 760) is designed to both temper as well as accommodate a preform (2, 422, 502, 622, 702) in the conveyor device (30, 34, 36, 38, 500, 530, 650, 730).

2. An apparatus for cooling molded preforms (2, 422, 502, 622, 702) comprising:
a conveyor device (30, 34, 36, 38, 500, 530, 650, 730) for conveying the molded preforms (2, 422, 502, 622, 702);
the conveyor device (30, 34, 36, 38, 500, 530, 650, 730) comprising at least one extraction plate (30, 530, 730, 730A) having at least one cooling cavity (32, 533, 733) for receiving and cooling a closed section (4, 704) of a molded preform (2, 422, 502, 622, 702);
at least one tempering insert (560, 660, 760) connected to the conveyor device (30, 34, 36, 38, 500, 530, 650, 730) for tempering a neck region (8, 508, 608, 708) of the preform by direct contact; and
at least one heat pipe (770, 770A) able to draw heat from the cooling cavity (32, 533, 733) to cool the closed section (4, 704) of the preform.

3. The apparatus for cooling molded preforms according to claim 1, characterized in that the tempering insert (560, 660, 760) corresponds to the shape of the threaded neck region (8, 508, 608, 708) of the preform (2, 422, 502, 622, 702).

4. The apparatus for cooling molded preforms according to claim 1, characterized in that the tempering insert (560, 660, 760) for tempering the neck region (8, 508, 608, 708) of the preform (2, 422, 502, 622, 702) is connected to an ejection device (564, 764).

5. The apparatus for cooling molded preforms according to claim 1, characterized in that the tempering insert (560, 660, 760) of the apparatus can be used only to cool or only to heat or both to cool as well as heat the neck region (8, 508, 608, 708) of the preform (2, 422, 502, 622, 702).

6. The apparatus for cooling molded preforms according to claim 2, characterized in that the at least one heat pipe (770, 770A) is connected to a heat dissipation area (780, 780A, 781).

7. The apparatus for cooling molded preforms according to claim 6, characterized in that the heat dissipation area (780, 780A, 781) has a large surface, particularly cooling fins.

8. The apparatus for cooling molded preforms according to claim 6, characterized in that the apparatus comprises a ventilator device (790) which produces a flow of air in the area of the heat dissipation area (780, 781) connected to at least one heat pipe (770),

9. The apparatus for cooling molded preforms according to claim 1, characterized in that the at least one tempering insert (560, 660, 760) can be brought into an eject position to eject the preform (2, 422, 502, 622, 702) from the conveyor device (30, 34, 36, 38, 500, 530, 650, 730) at which the preform is released from the tempering insert (560, 660, 760) in its open position.

10. A method for cooling molded preforms with an apparatus according to claim 1 comprising the following steps:
injection molding a preform (2, 422, 502, 622, 702);
removing the molded preform from a mold core;
transferring the preform to a conveyor device (30, 34, 36, 38, 500, 530, 650, 730); and
cooling a closed section (4, 704) of the preform and simultaneously tempering a neck region (8, 508, 608, 708) of the preform by direct contact with at least one tempering insert (560, 660, 760) in the conveyor device.

11. The apparatus for cooling molded preforms according to claim 2, characterized in that the tempering insert (560, 660, 760) corresponds to the shape of the threaded neck region (8, 508, 608, 708) of the preform (2, 422, 502, 622, 702).

12. The apparatus for cooling molded preforms according to claim 2, characterized in that the tempering insert (560, 660, 760) for tempering the neck region (8, 508, 608, 708) of the preform (2, 422, 502, 622, 702) is connected to an ejection device (564, 764).

13. The apparatus for cooling molded preforms according to claim 2, characterized in that the tempering insert (560, 660, 760) of the apparatus can be used only to cool or only to heat or both to cool as well as heat the neck region (8, 508, 608, 708) of the preform (2, 422, 502, 622, 702).

14. The apparatus for cooling molded preforms according to claim 2, characterized in that the at least one tempering insert (560, 660, 760) can be brought into an eject position to eject the preform (2, 422, 502, 622, 702) from the conveyor device (30, 34, 36, 38, 500, 530, 650, 730) at which the preform in an open position.

15. A method for cooling molded preforms with an apparatus according to claim 2 comprising the following steps:
injection molding a preform (2, 422, 502, 622, 702);
removing the molded preform from a mold core;
transferring the preform to a conveyor device (30, 34, 36, 38, 500, 530, 650, 730); and
cooling a closed section (4, 704) of the preform and simultaneously tempering a neck region (8, 508, 608, 708) of the preform by direct contact with at least one tempering insert (560, 660, 760) in the conveyor device.
